(19) United States
(12) Patent Application Publication
(10) Pub. No.: US 2025/0327478 A1
(43) Pub. Date: Oct. 23, 2025

(54) CONTROL DEVICE

(71) Applicant: Wolf Tooth Components, LLC, Burnsville, MN (US)

(72) Inventor: Michael W. Pfeiffer, Burnsville, MN (US)

(73) Assignee: Wolf Tooth Components, LLC, Burnsville, MN (US)

(21) Appl. No.: 19/184,906

(22) Filed: Apr. 21, 2025

Related U.S. Application Data
(60) Provisional application No. 63/636,331, filed on Apr. 19, 2024.

(51) Int. Cl. F16C 1/18; B62J 1/08; B62K 23/06; F16C 1/14

(52) U.S. Cl. CPC F16C 1/18; B62J 1/08; B62K 23/06; F16C 1/145; B62J 2001/085

(57) ABSTRACT

A control device includes a base, a cam body, a bearing, and an actuation lever. The bearing is mounted in the cam body and supported by the base, and the actuation lever is pivotally coupled with the base via the cam body and the bearing for rotation relative to the base.

### CROSS-REFERENCE TO RELATED APPLICATIONS

This application claims priority under 35 U.S.C. 119(e) to U.S. Provisional Patent Application Ser. No. 63/636,331 filed on Apr. 19, 2024, and incorporated herein by reference. In this instance, the day that is 12 months after the filing date of the provisional application falls on a Saturday (i.e., Saturday, Apr. 19, 2025). As such, the period of pendency of the provisional application is extended to the next succeeding business day (i.e., Monday, Apr. 21, 2025). See 35 U.S.C. 119(e)(3).

### BACKGROUND

The present disclosure relates generally to a control device and, more specifically, relates to a control device for actuating a height adjustment device for a saddle of a bicycle.

### BRIEF DESCRIPTION OF THE DRAWINGS

FIG. 1 is an exploded top perspective view of an example of a control device in accordance with the present disclosure.

FIG. 2 is an exploded bottom perspective view of the control device of FIG. 1.

FIG. 3 is an assembled top perspective view of the control device of FIG. 1.

FIG. 4 is an assembled bottom perspective view of the control device of FIG. 1.

FIG. 5 is an assembled front view of the control device of FIG. 1.

FIG. 6 is an assembled bottom view of the control device of FIG. 1.

FIG. 6A is a cross-sectional view of the control device of FIG. 6 from the perspective of line A-A.

FIG. 7 is an assembled bottom view of an example of the control device of FIG. 1 in an unactuated state.

FIG. 8 is an assembled bottom view of an example of the control device of FIG. 1 in an actuated state.

FIG. 9 is a bottom view of an example of the control device of FIG. 1 in an unactuated state with the actuation lever removed.

FIG. 9A is a bottom view of the control device of FIG. 9 with an actuation cable secured thereto.

FIG. 10 is a bottom view of an example of the control device of FIG. 1 in an actuated state with the actuation lever removed.

FIG. 10A is a bottom view of the control device of FIG. 10 with an actuation cable secured thereto.

FIG. 11 is a bottom view of an example of the cam body of the control device of FIG. 1.

FIG. 12 is an example of a graph illustrating an example of leverage ratio versus lever rotation for an example of the control device of FIG. 1.

FIG. 13 is an assembled bottom view of an example of the control device of FIG. 1 in one unactuated position.

FIG. 14 is an assembled bottom view of an example of the control device of FIG. 1 in another unactuated position.

FIG. 15 is a schematic view illustrating an example implementation of a control device in accordance with the present disclosure.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims.

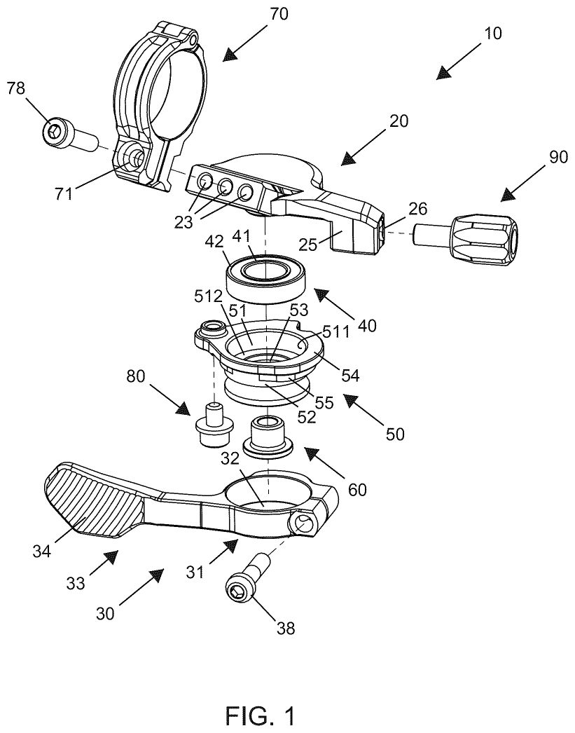

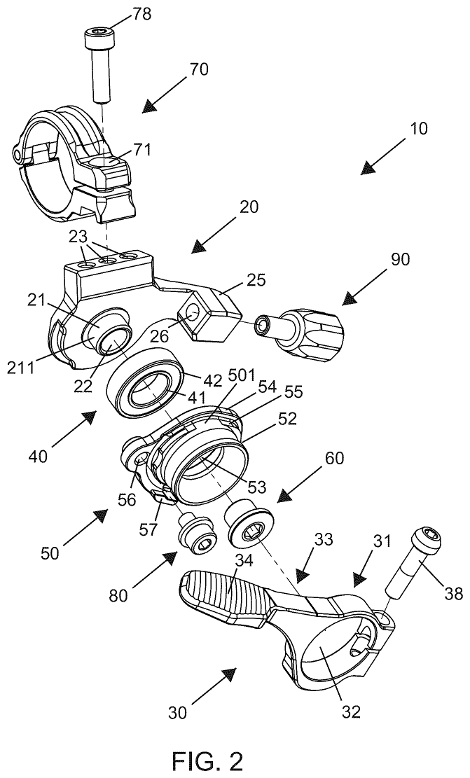

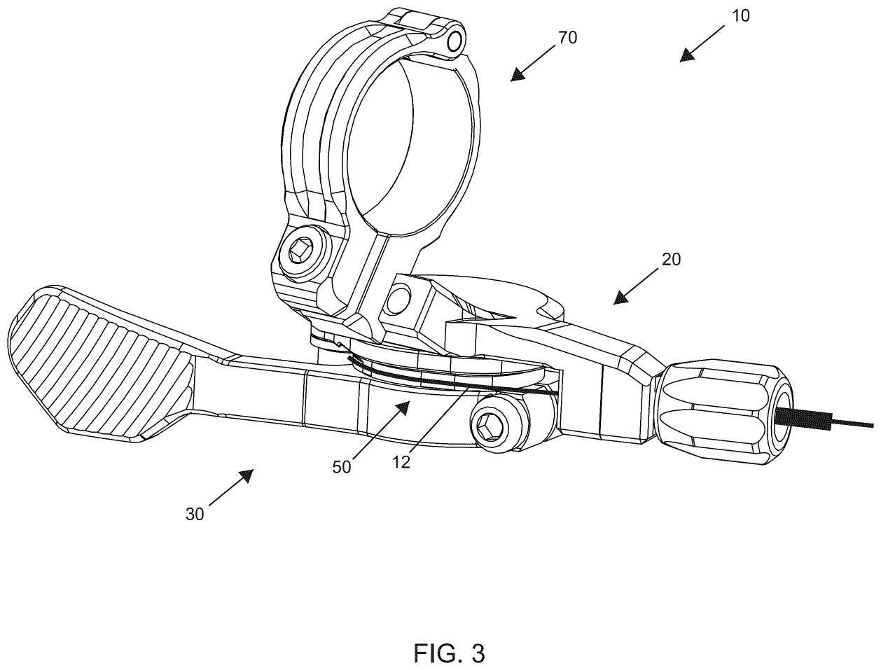

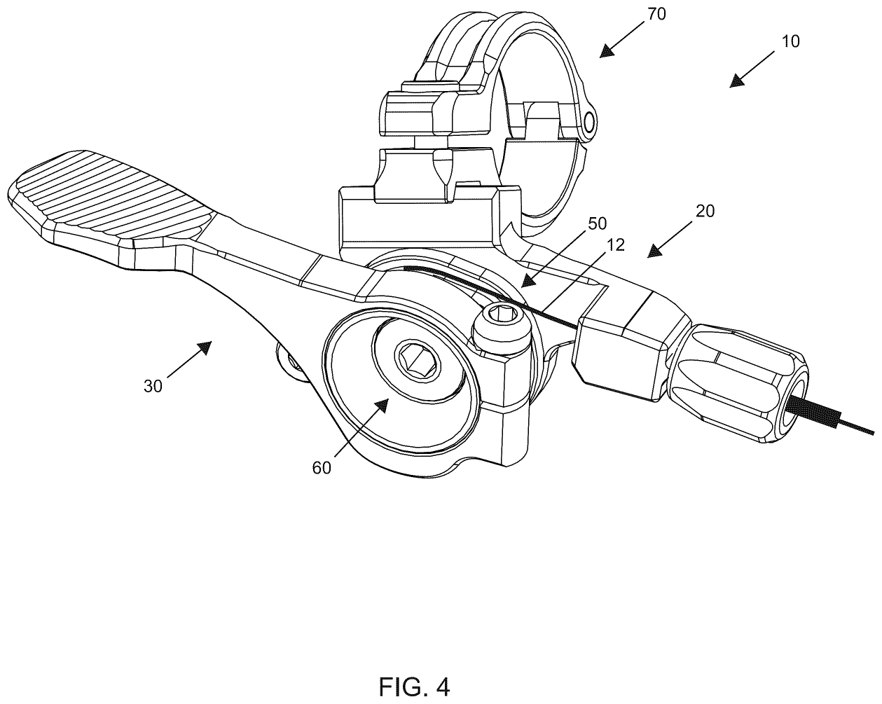

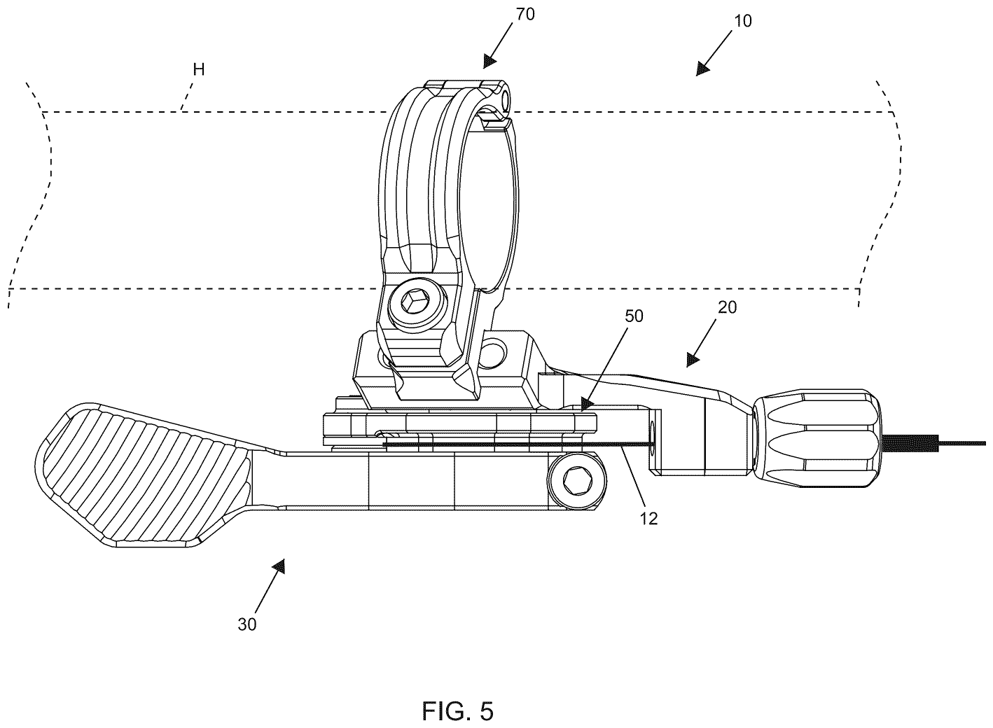

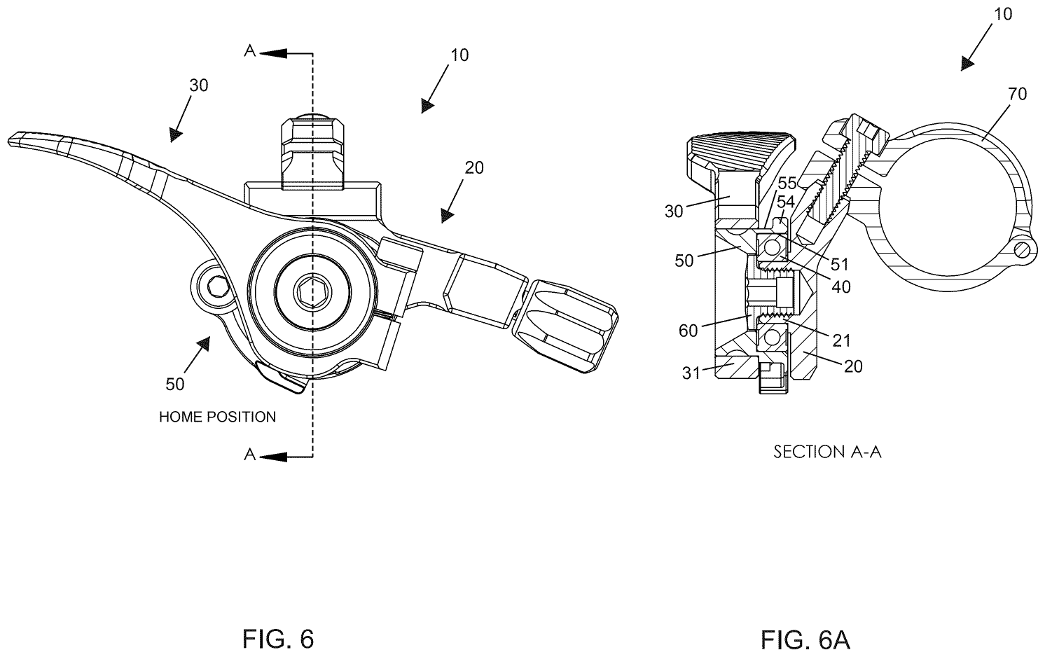

FIG. 1 is an exploded top perspective view of an example of a control device 10 in accordance with the present disclosure, and FIG. 2 is an exploded bottom perspective view of control device 10. In addition, FIG. 3 is an assembled top perspective view of control device 10, FIG. 4 is an assembled bottom perspective view of control device 10, FIG. 5 is an assembled front view of control device 10, and FIG. 6 is an assembled bottom view of control device 10. Furthermore, FIG. 6A is a cross-sectional view of control device 10 from the perspective of line A-A of FIG. 6.

In the illustrated example, control device 10 includes a base 20, an actuation lever 30, a bearing 40, and a cam body 50. As described herein, bearing 40 is mounted in cam body 50 and supported by base 20, and actuation lever 30 is secured to cam body 50 such that cam body 50, with actuation lever 30 secured thereto, is rotatable relative to base 20 via bearing 40. In one implementation, bearing 40 is a rolling-element bearing such as a ball bearing.

In the illustrated example, base 20 includes a standoff 21, bearing 40 includes an inner race 41 and an outer race 42, and cam body 50 includes a seat 51. In one implementation, bearing 40 is mounted (for example, press fit) within seat 51 of cam body 50 such that outer race 42 of bearing 40 contacts an inner diameter surface 511 of seat 51 (with seat 51, in one implementation, also including a lip 512 as a support for bearing 40). In addition, standoff 21 is extended through bearing 40 such that an outer diameter surface 211 of standoff 21 contacts inner race 41 of bearing 40. As such, actuation lever 30, as secured to cam body 50, is pivotally coupled with base 20, via cam body 50 and bearing 40, for rotation relative to base 20.

In the illustrated example, actuation lever 30 includes a collar portion 31 having a hole 32 therethrough and a blade portion 33 extended from collar portion 31, and cam body 50 includes a sleeve 52 having a hole 53 therethrough and a flange 54 at one end. In one implementation, collar portion 31 of actuation lever 30 is of a ring or annular shape, and is secured to sleeve 52 of cam body 50. In one implementation, collar portion 31 is secured to sleeve 52 with a collar bolt 38. As such, actuation lever 30, as secured to cam body 50, is pivotally coupled with base 20, via cam body 50 and bearing 40, for rotation relative to base 20.

In the illustrated example, standoff 21 of base 20 includes a threaded hole 22 such that an assembly bolt 60 (for example, a chainring bolt) extended through hole 53 of cam body 50 is threaded into threaded hole 22 to secure cam body 50 to base 20, with actuation lever 30 coupled to cam body 50 and bearing 40 mounted in cam body 50.

In one example, control device 10 includes a fitment or mount 70. In the illustrated example, base 20 includes a threaded hole 23, and mount 70 has a hole 71 therethrough such that a mounting bolt 78 extended through hole 71 is threaded into threaded hole 23 to secure base 20 to mount 70. In one implementation, base 20 has a series of threaded holes 23 formed therein such that base 20 (with cam body 50, bearing 40, and actuation lever 30 rotatably secured to base 20) may be laterally adjusted relative to mount 70 based on which threaded hole 23 is used.

In the illustrated example, cam body 50 has a cam surface 55 formed on an outer diameter surface 501 thereof and base 20 includes a projection or tab 25 having a cable passage 26 formed therethrough such that an actuation or control cable 12 (see FIGS. 3, 4, 5) may be fed through cable passage 26 and routed along cam surface 55. As such, in one implementation, a cable pinch bolt or fixing bolt 80 is threaded into a threaded hole 56 of cam body 50 and tightened to capture and secure an end portion of actuation or control cable 12 to cam body 50. In one example, a barrel adjuster 90 is threaded into cable passage 26 such that tension on actuation or control cable 12 passing through cable passage 26 (and secured to cam body 50 by cable pinch bolt or fixing bolt 80) may be adjusted.

More specifically, as illustrated in the examples of FIGS. 3, 4, 5, actuation or control cable 12 is fed through barrel adjuster 90 and tab 25 of base 20, including, more specifically, cable passage 26 of tab 25, and routed along cam surface 55 (see also FIGS. 1, 2) of cam body 50, such that an end portion of actuation or control cable 12 is captured and secured to cam body 50, for example, by cable pinch bolt or fixing bolt 80.

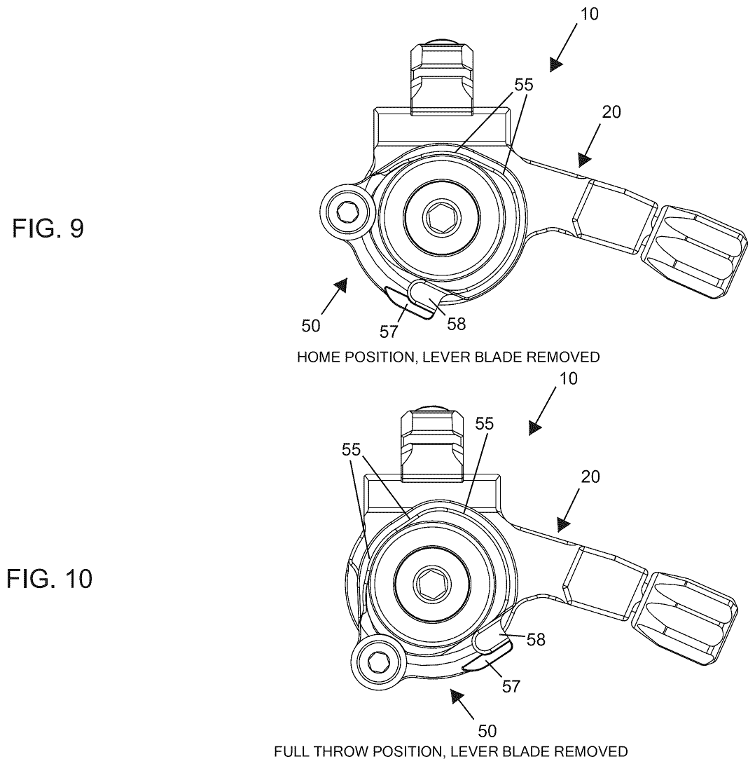

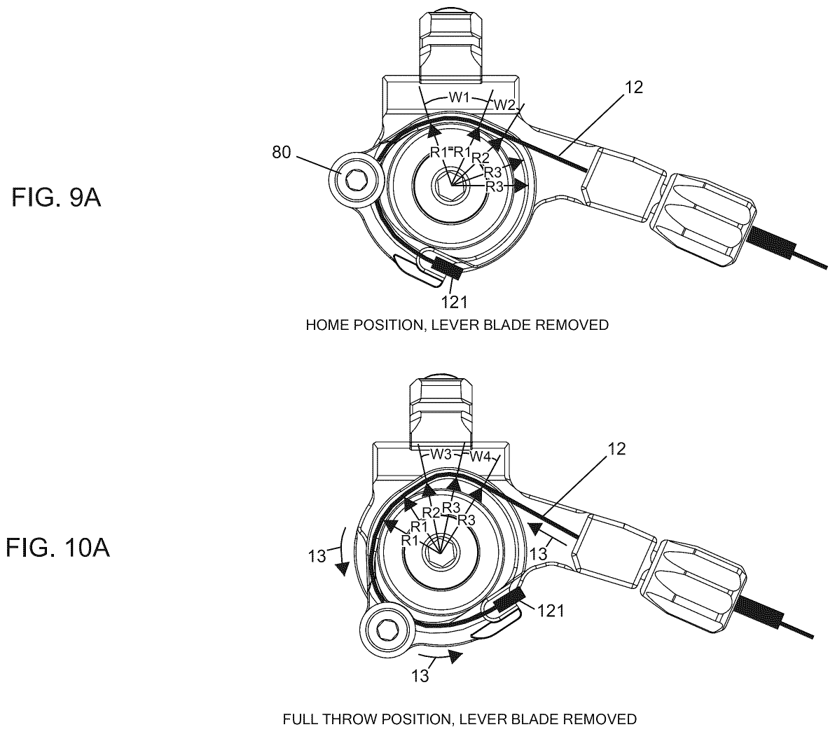

In one implementation, cam body 50 has a cable guide feature 57 (see FIG. 2) formed thereon such that an end portion of actuation or control cable 12 is routed along cable guide feature 57 and restrained by cable guide feature 57. As such, an end portion of actuation or control cable 12 is wrapped around cam body 50 (see FIGS. 9A, 10A). In one implementation, cam body 50 has a receiving pocket 58 (see FIGS. 9, 10) formed therein to receive a cable end cap 121 (see FIGS. 9A, 10A).

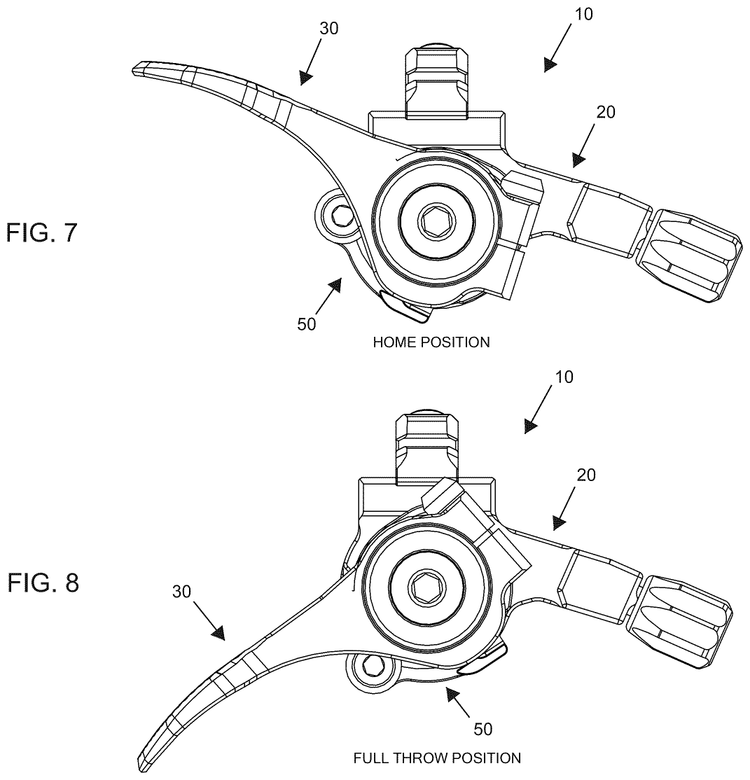

FIG. 7 is an assembled bottom view of an example of control device 10 in an unactuated state, and FIG. 8 is an assembled bottom view of an example of control device 10 in an actuated state. As illustrated in the examples of FIGS. 7 and 8, actuation lever 30 (as secured to cam body 50) is rotated between a “home” (neutral or unactuated) position and a “full throw” (or full actuation) position such that rotation of actuation lever 30 actuates (or pulls) actuation or control cable 12. More specifically, as illustrated in the example of FIG. 7, actuation lever 30 and, therefore, control device 10, is in an unactuated (or neutral) state such that pull is not applied to actuation or control cable 12 and, as illustrated in the example of FIG. 8, actuation lever 30 and, therefore, control device 10, is in an actuated state such that pull is applied to actuation or control cable 12, as represented by arrow 13 (see FIG. 10A). In examples, actuation lever 30 is pivoted or rotated relative to base 20 by contact with a contact surface 34 of blade portion 33 (see also FIGS. 1, 2). Contact with contact surface 34 of blade portion 33 may be established or provided, for example, by a thumb (for example, left thumb) of a user.

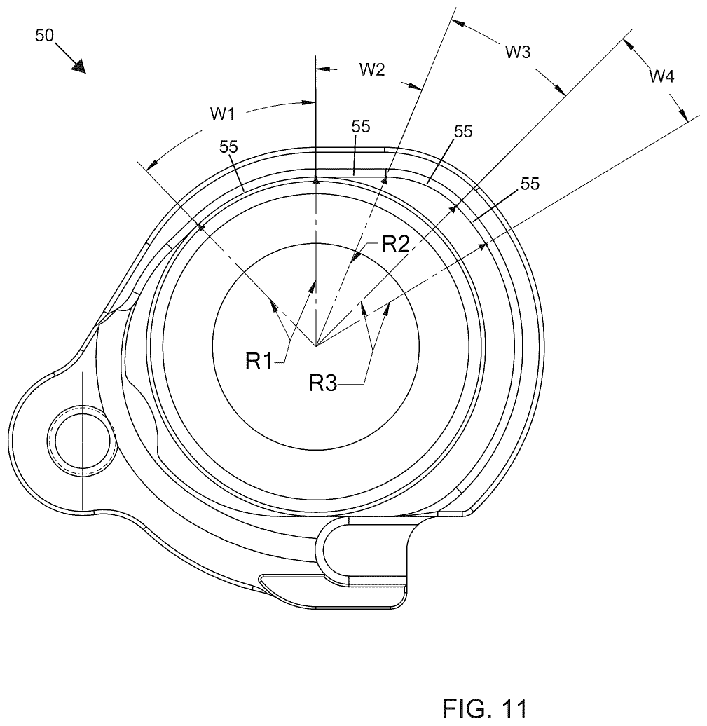

FIG. 9 is a bottom view of an example of control device 10 in an unactuated state with actuation lever 30 removed, and FIG. 10 is a bottom view of an example of control device 10 in an actuated state with actuation lever 30 removed. In addition, FIG. 9A is a bottom view of control device 10 in the unactuated state with actuation lever 30 removed and actuation or control cable 12 secured thereto, and FIG. 10A is a bottom view of control device 10 in the actuated state with actuation lever 30 removed and actuation cable 12 secured thereto. Furthermore, FIG. 11 is a bottom view of cam body 50.

In one implementation, as illustrated in the examples of FIGS. 9A, 10A, and 11, cam surface 55 of cam body 50 has a contact or wrap radius R1, a contact or wrap radius R2, and a contact or wrap radius R3 (each measured from a center of cam body 50 to cam surface 55). In one implementation, wrap radius R2 is greater than wrap radius R1, and wrap radius R3 is greater than wrap radius R2. In one implementation, wrap radius R1 is in a range of approximately 9 mm to approximately 11 mm, wrap radius R2 is in a range of approximately 10 mm to approximately 12 mm, and wrap radius R3 is in a range of approximately 11 mm to approximately 13 mm. In one implementation, wrap radius R1 is approximately 10.25 mm, wrap radius R2 is approximately 11 mm, and wrap radius R3 is approximately 12 mm.

In one implementation, bearing 40 has an outer diameter in a range of approximately 10 mm to approximately 30 mm, and in one implementation, bearing 40 has an outer diameter of approximately 19 mm. Thus, in one implementation, wrap radii R1, R2, and R3 are each greater than an outer diameter of bearing 40.

In one implementation, as illustrated in the example of FIG. 9A, in the unactuated (or neutral) state, control device 10 has a contact or wrap angle W1 and a contact or wrap angle W2 (each establishing a measurement of a length of actuation or control cable 12 routed along cam surface 55 of cam body 50). (See also FIG. 11.) In one implementation, wrap angle W1 is in a range of approximately 42 degrees to approximately 46 degrees, and wrap angle W2 is in a range of approximately 20 degrees to approximately 25 degrees. In one implementation, wrap angle W1 is approximately 44 degrees, and wrap angle W2 is approximately 22.5 degrees.

In one implementation, as illustrated in the example of FIG. 10A, in the actuated state, control device 10 has a further contact or wrap angle W3 and a further contact or wrap angle W4 (each establishing a measurement of a further length of actuation or control cable 12 routed along cam surface 55 of cam body 50). (See also FIG. 11.) In one implementation, wrap angle W3 is in a range of approximately 20 degrees to approximately 25 degrees, and wrap angle W4 is in a range of approximately 11 degrees to approximately 17 degrees. In one implementation, wrap angle W3 is approximately 22.5 degrees, and wrap angle W4 is in a range of approximately 13 degrees to approximately 15 degrees.

In one implementation, as illustrated in the examples of FIGS. 9A, 10A, and 11, a wrap radius of wrap angle W1 is substantially constant, a wrap radius of wrap angle W2 increases in a direction from wrap angle W1 to wrap angle W3, a wrap radius of wrap angle W3 increases in a direction from wrap angle W2 to wrap angle W4, and a wrap radius of wrap angle W4 is substantially constant. More specifically, wrap angle W1 has a substantially constant wrap radius (for example, wrap radius R1), wrap angle W2 has an increasing wrap radius (for example, from wrap radius R1 to wrap radius R2), wrap angle W3 has an increasing wrap radius (for example, from wrap radius R2 to wrap radius R3), and wrap angle W4 has a substantially constant wrap radius (for example, wrap radius R3).

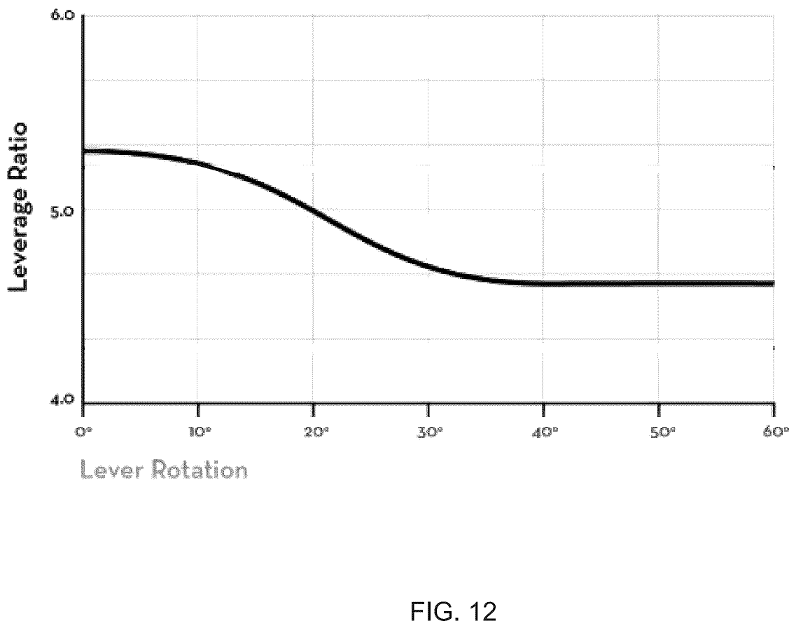

FIG. 12 is an example of a graph illustrating an example of leverage ratio versus lever rotation for control device 10. As illustrated in the example graph of FIG. 12, with control device 10, an initial leverage ratio (and resulting amount of “pull” on an actuation or control cable) over an initial amount of lever rotation (for example, from a) 0 degrees to b) a range of approximately 5 degrees to approximately 10 degrees) is a substantially constant, relatively “high” leverage ratio, a subsequent or intermediate leverage ratio over a further amount of lever rotation (for example, from b) a range of approximately 5 degrees to approximately 10 degrees to c) a range of approximately 30 degrees to approximately 35 degrees) is a variable decreasing leverage ratio, and a final leverage ratio over a final amount of lever rotation (for example, from c) a range of approximately 30 degrees to approximately 35 degrees to d) approximately 60 degrees) is a substantially constant, relatively “low” leverage ratio. Thus, control device 10 provides a greater leverage at the beginning of actuation of actuation lever 30, with decreasing leverage thereafter and substantially constant leverage further thereafter.

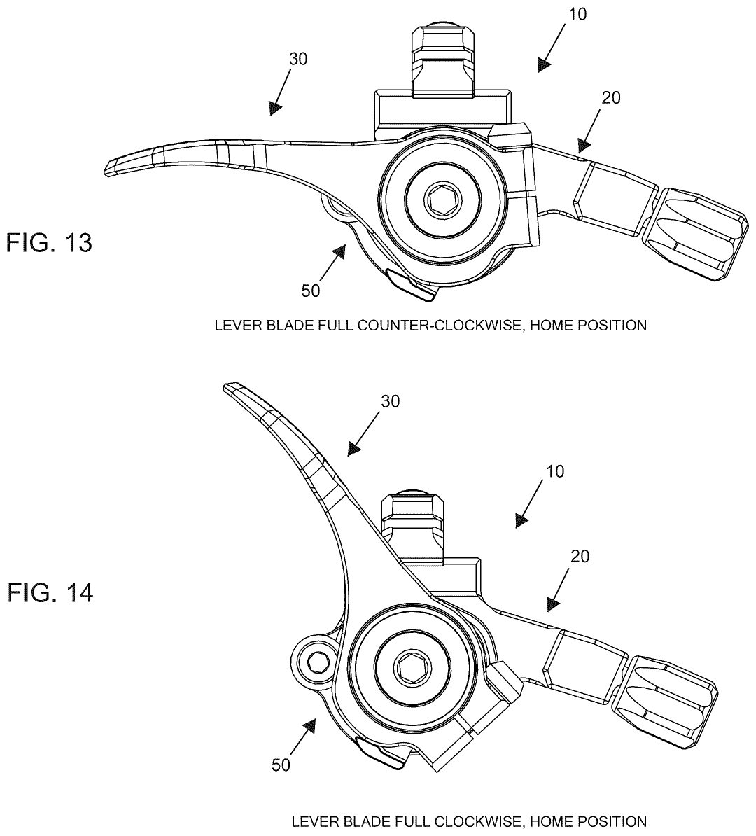

FIG. 13 is an assembled bottom view of an example of control device 10 in one unactuated position, and FIG. 14 is an assembled bottom view of an example of control device 10 in another unactuated position. As illustrated in the examples of FIGS. 13 and 14, actuation lever 30 is rotatably adjustable relative to cam body 50. More specifically, actuation lever 30 is rotatably adjustable relative to cam body 50 to vary an initial (“home”) position of actuation lever 30 and thereby establish the unactuated position of actuation lever 30. In one example, actuation lever 30 is rotated around sleeve 52 of cam body 50 (see FIGS. 1, 2). As such, adjustment of a starting position of actuation lever 30 may be established independent of tension applied to an actuation or control cable.

More specifically, in one example, with collar bolt 38 loosened, actuation lever 30 may be rotated relative to cam body 50 (for example, rotated counter-clockwise as illustrated in the example of FIG. 13 and rotated clockwise as illustrated in the example of FIG. 14) to establish different (“home”) positions of actuation lever 30. As such, collar bolt 38 is tightened to secure actuation lever 30 in an established “home” position. In one implementation, actuation lever 30 is rotatable relative to cam body 50 over a range of a) 0 degrees to b) approximately 40 degrees to approximately 50 degrees to establish the “home” or starting position of actuation lever 30. Thus, actuation lever 30 is adjustably secured to cam body 50.

In one implementation, as illustrated, for example, in FIGS. 1-5, mount 70 of control device 10 is a bar clamp mount for mounting control device 10 to a handlebar of a bicycle. More specifically, mount 70 clamps around a portion of a handlebar H of a bicycle for mounting control device 10 directly to the handlebar (as represented by broken lines in the example of FIG. 5). In other implementations, other fitments, mounts or mounting systems may be provided, including, for example, a SRAM MatchMaker X mount, a Shimano I-Spec II mount, or a Shimano I-Spec AB mount, to support other mounting arrangements or configurations of control device 10.

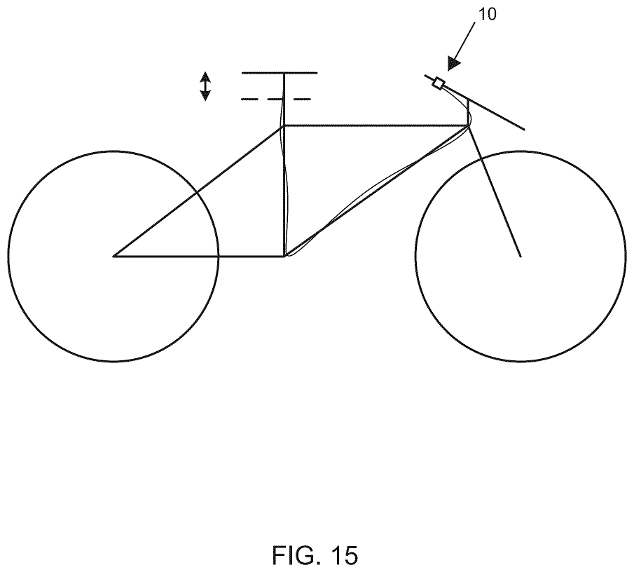

In one implementation, as schematically illustrated in the example of FIG. 15, control device 10 is used to control or actuate a height adjustment device for a saddle of a bicycle. More specifically, control device 10 may be mounted on a bicycle (for example, a handlebar of a bicycle), such that operation or actuation of control device 10 may be used to apply pull to an actuation or control cable coupled with a height adjustment device for a saddle of a bicycle. Although the disclosed control device is illustrated and described as being used to control or actuate a height adjustment device for a saddle of a bicycle, the disclosed control device may be used to control or actuate other cable-actuated or cable-controlled elements, components, systems, structures, or devices.

Although illustrated as a left-actuated control device, control device 10 may be implemented as a right-actuated control device wherein components of control device 10 are mirrored about a rotational axis of control device 10.

A control device as disclosed herein provides for improved operation and actuation or control of a cable-actuated or cable-controlled element, component, system, structure, or device. For example, a control device as disclosed herein provides a smooth, precise, quick actuation while providing more leverage at the beginning of actuation.

Although specific examples have been illustrated and described herein, it will be appreciated by those of ordinary skill in the art that a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

What is claimed is:

1. A control device, comprising:
a base;
a cam body;
a bearing mounted in the cam body and supported by the base; and
an actuation lever pivotally coupled with the base via the cam body and the bearing for rotation relative to the base.

2. The control device of claim 1, the base including a standoff and the cam body including a seat, the bearing mounted within the seat of the cam body, and the standoff of the base extended through the bearing.

3. The control device of claim 1, further comprising:
a bolt to secure the cam body to the base.

4. The control device of claim 1, the cam body having a cam surface along which a control cable is to be routed.

5. The control device of claim 4, the cam surface having a first wrap radius, a second wrap radius greater than the first wrap radius, and a third wrap radius greater than the second wrap radius.

6. The control device of claim 5, the first wrap radius, the second wrap radius, and the third wrap radius each being greater than an outer diameter of the bearing.

7. The control device of claim 4, further comprising:
a cable fixing bolt to secure the control cable to the cam body.

8. The control device of claim 1, the actuation lever secured to the cam body.

9. The control device of claim 1, the actuation lever rotatable relative to the cam body.

10. The control device of claim 1, an initial leverage ratio over an initial amount of rotation of the actuation lever being substantially constant, a subsequent leverage ratio over a further amount of rotation of the actuation lever being a variable decreasing leverage ratio, and a final leverage ratio over a final amount of rotation of the actuation lever being substantially constant.

11. A control device, comprising:
a cam body;
an actuation lever extended from the cam body;
a bearing mounted in the cam body; and
a base having a standoff extended through the bearing;
the actuation lever pivotally coupled with the base via the cam body and the bearing for rotation relative to the base.

12. The control device of claim 11, the bearing having an inner race and an outer race, the standoff extended through the bearing such that the standoff contacts the inner race of the bearing.

13. The control device of claim 12, the cam body including a seat, the bearing mounted within the seat such that the outer race of the bearing contacts the seat.

14. The control device of claim 11, further comprising:
a bolt extended through a hole of the cam body to secure the cam body to the base.

15. The control device of claim 11, the cam body having a cam surface along which a control cable is to be routed.

16. The control device of claim 15, the cam surface establishing a first wrap angle, a second wrap angle, a third wrap angle, and a fourth wrap angle of the control device,
the first wrap angle having a substantially constant wrap radius, the second wrap angle having an increasing wrap radius, the third wrap angle having another increasing wrap radius, and the fourth wrap angle having another substantially constant wrap radius.

17. The control device of claim 15, the base having a cable passage through which the control cable is to be fed, and further comprising a cable fixing bolt to secure the control cable to the cam body.

18. The control device of claim 15, the cam body having a cable guide feature formed thereon along which the control cable is to be routed.

19. The control device of claim 11, the actuation lever including a collar portion and a blade portion extended from the collar portion, the collar portion of the actuation lever adjustably secured to the cam body.

20. The control device of claim 11, the control device to provide a greater leverage at a beginning of actuation of the actuation lever, decreasing leverage thereafter, and substantially constant leverage further thereafter.
